(19) United States
(12) Patent Application Publication
(10) Pub. No.: US 2026/0112988 A1
(43) Pub. Date: Apr. 23, 2026

(54) Motor Driver

(71) Applicant: Siemens Aktiengesellschaft, München (DE)

(72) Inventors: Hua Liao, Peking, BJ (CN); Jun Ping Zhang, Nanjing, JS (CN); Xiao Shan Luo, Nanjing, JS (CN)

(73) Assignee: Siemens Aktiengesellschaft, München (DE)

(21) Appl. No.: 19/485,765

(22) PCT Filed: May 29, 2023
(86) PCT No.: PCT/CN2023/096919

§ 371 Date: Nov. 19, 2025

(51) Int. Cl. H02P 27/06

(52) U.S. Cl. CPC H02P 27/06

(57) ABSTRACT

A motor driver with an inverter circuit having a first to a third DC/AC conversion branch in parallel between output terminals of a direct current link circuit; and a filter circuit with a three-phase inductor. Head terminals of the inductor are connected to midpoints of the branches and tail terminals output three phase voltages. A compensation circuit includes a coupling inductor with a center tap and a solid-state circuit breaker. The coupling inductor is coupled to the inductor. A moving point of the solid-state circuit breaker includes a first and a second switch contact. The first switch contact is connected to a head terminal of the inductor, the second switch contact is connected to the center tap of the inductor, the solid-state circuit breaker is connected to a midpoint of a half-bridge branch, and a tail terminal of the inductor is connected to a midpoint of a capacitor branch.

### CROSS-REFERENCE TO RELATED APPLICATIONS

This application is a U.S. National Stage Application of International Application No. PCT/CN2023/096919 filed May 29, 2023, which designates the United States of America, the contents of which are hereby incorporated by reference in their entirety.

### TECHNICAL FIELD

The present disclosure generally relates to circuits. Various embodiments of the teachings herein include motor drivers.

### BACKGROUND

A variable-frequency Converter (VFC) is usually widely used in the motor drive and servo industry. The VFC using the PWM technology generates a high-frequency common-mode voltage on a motor terminal, which leads to a bearing current and may lead to serious bearing damage. In addition, the high-frequency common-mode voltage may bring EMI problems. In order to suppress these adverse effects on motor-driven products and improve system reliability, an output common-mode voltage of the variable-frequency drive should be limited.

FIG. 1 is a circuit topology diagram of a motor driver from the prior art. The motor driver has a three-phase diode rectifier bridge and adopts a three-phase two-level half bridge as a DC/AC inverter. R, S, and T are input terminals of a three-phase power grid, and U, V, and W are output terminals for a three-phase motor. C1 is a direct current link capacitor. R1, T8, and D7 are used to dissipate an instantaneous direct current link high voltage generated during regeneration of energy by the motor. DC/AC output voltages V1, V2, and V3 include high-frequency common-mode voltages, which may be applied to motor terminals and generate a harmful motor bearing current.

In some applications with long motor cables, a three-phase LC filter may be mounted to suppress the overvoltage over the motor terminal. The output filter can reduce high-frequency components in a differential-mode voltage, which has no impact on the common-mode voltage.

In order to eliminate the bearing current caused by the common-mode voltage, some measures are taken. On the one hand, a grounding brush on a motor shaft may be used to bypass the bearing current, but the grounding brush is a wearing part and needs regular maintenance and replacement. Increasing bearing insulation is another method to eliminate the bearing current but increases the system cost and may bring additional heat dissipation problems. On the other hand, an improved output filter may be used to suppress the common-mode voltage. For example, the direct current link capacitor is divided into two capacitors in series. A three-phase filter is added at an output side, and a star connection point of a filter capacitor is connected to a midpoint of the direct current link capacitor. This solution can help reduce the high-frequency components in both the differential-mode voltage and the common-mode voltage. However, in order to obtain better filtering effect, the output filter needs to be very large, and the common-mode voltage cannot be completely eliminated.

### SUMMARY

The summary below is offered to provide a basic understanding of some aspects of the present disclosure. This summary is not an exhaustive overview thereof. The summary is neither intended to determine key or important parts of the teachings herein, nor intended to limit the scope of the present disclosure. The purpose is only to give some concepts in a simplified form as a prelude to the more detailed description discussed later. In view of the above, the present disclosure describes motor drivers capable of eliminating a common-mode voltage.

For example, some embodiments include a motor driver (20), comprising a rectifier circuit (202), a direct current link circuit (204), an inverter circuit (206), a filter circuit (208), and a compensation circuit (210), wherein the rectifier circuit (202) comprises three AC/DC conversion branches configured to convert an inputted alternating current voltage into a direct current voltage; the direct current link circuit (204) is connected between a positive output terminal and a negative output terminal of the rectifier circuit (202), and the direct current link circuit (202) comprises an energy release branch (2042), a capacitor branch (2044), and a half-bridge branch (2046) that are connected in parallel, wherein the capacitor branch (2044) comprises two capacitors (C1) and (C2), and the half-bridge branch (2046) comprises two switching devices (T9) and (T10); the inverter circuit (206) comprises a first DC/AC conversion branch to a third DC/AC conversion branch arranged in parallel between a positive output terminal and a negative output terminal of the direct current link circuit (204), and each of the first DC/AC conversion branch to the third DC/AC conversion branch comprises two of switching devices (T1, T2, T3, T4, T5, T6); the filter circuit (208) comprises a three-phase inductor (Labc), head terminals of three inductors of the three-phase inductor (Labc) are respectively connected to midpoints (V1, V2, and V3) of the first DC/AC conversion branch to the third DC/AC conversion branch, and tail terminals of the three inductors output three phase voltages (U, V, and W); and the compensation circuit (210) comprises a coupling inductor (L12) with a center tap and a solid-state circuit breaker (K1), and the coupling inductor (L12) is coupled to the three-phase inductor (Labc), wherein a moving point of the solid-state circuit breaker (K1) comprises a first switch contact (1) and a second switch contact (2), the first switch contact (1) is connected to a head terminal of the coupling inductor (L12), the second switch contact (2) is connected to the center tap (CP) of the coupling inductor (L12), the solid-state circuit breaker (K1) is connected to a midpoint (V4) of the half-bridge branch (2046), and a tail terminal of the coupling inductor (L12) is connected to a midpoint (O) of the capacitor branch.

In some embodiments, the coupling inductor (L12) comprises a first inductor (L1) and a second inductor (L2), the center tap (CP) is connected between the first inductor (L1) and the second inductor (L2), a number of turns of the first inductor (L1) is twice a number of turns of the second inductor (L2), and the three inductors of the three-phase inductor (Labc) have a same number of turns as the number of turns of the second inductor (L2).

In some embodiments, switching states of the two switching devices (T9, T10) of the half-bridge branch (2046) and which one of the first switch contact (1) and the second switch contact (2) to be connected are configured to be controlled according to a switching state of the switching device of each of the first DC/AC conversion branch to the third DC/AC conversion branch, so that a magnitude of a compensation voltage generated by the coupling inductor (L12) is equal to a magnitude of a common-mode voltage generated by the inverter circuit (206).

In some embodiments, the head terminals of the coupling inductor (L12) and the three-phase inductor (Labc) are dotted terminals or undotted terminals, and in the case of dotted terminals and the case of undotted terminals, the switching states of the two switching devices (T9 and T10) of the half-bridge branch (2046) are opposite.

In some embodiments, each of the switching devices comprises a fully-controlled power switching tube and an anti-parallel power diode.

As another example, some embodiments include a motor driver (40), comprising a rectifier circuit (402), a direct current link circuit (404), an inverter circuit (406), a filter circuit (408), and a compensation circuit (410), wherein the rectifier circuit (402) comprises three AC/DC conversion branch circuits configured to convert an inputted alternating current voltage into a direct current voltage; the direct current link circuit (404) is connected between a positive output terminal and a negative output terminal of the rectifier circuit (402), and the direct current link circuit (404) comprises an energy release branch (4042), a capacitor branch (4044), a first half-bridge branch (4046), and a second half-bridge branch (4048) that are connected in parallel, wherein the capacitor branch (4044) comprises two capacitors (C1 and C2), and each of the first half-bridge branch (4046) and the second half-bridge branch (4048) comprises two of switching devices (T9, T10, T11, T12); the inverter circuit (406) comprises a first DC/AC conversion branch to a third DC/AC conversion branch arranged in parallel between a positive output terminal and a negative output terminal of the direct current link circuit (404), and each of the first DC/AC conversion branch to the third DC/AC conversion branch comprises two of switching devices (T1, T2, T3, T4, T5, T6); the filter circuit (408) comprises a three-phase inductor (Labc), head terminals of three inductors of the three-phase inductor (Labc) are respectively connected to midpoints (V1, V2, and V3) of the first DC/AC conversion branch to the third DC/AC conversion branch, and tail terminals of the three inductors output three phase voltages (U, V, and W); and the compensation circuit (410) comprises a first coupling inductor (L11) and a second coupling inductor (L22), wherein a head terminal of the first coupling inductor (L11) is connected to a midpoint (V6) of the second half-bridge branch (4048), a head terminal of the second coupling inductor (L22) is connected to a midpoint (V5) of the first half-bridge branch (4046), and tail terminals of the second coupling inductor (L22) and the first coupling inductor (L11) are connected to a midpoint (O) of the capacitor branch (4044).

In some embodiments, a number of turns of the second coupling inductor (L22) is 3 times a number of turns of the first coupling inductor (L11), and the three inductors of the three-phase inductor (Labc) have a same number of turns as the number of turns of the first coupling inductor (L11).

In some embodiments, switching states of the switching devices of each of the first half-bridge branch (4046) and the second half-bridge branch (4048) are configured to be controlled according to a switching state of each of the first DC/AC conversion branch to the third DC/AC conversion branch, so that a magnitude of a compensation voltage generated by the first coupling inductor (L11) or the second coupling inductor (L22) is equal to a magnitude of a common-mode voltage generated by the inverter circuit (406).

In some embodiments, the head terminals of the first coupling inductor (L11) and the second coupling inductor (L22) are dotted terminals, the head terminals of the first coupling inductor (L11) and the second coupling inductor (L22) and head terminals of the three-phase inductor (Labc) are dotted terminals or undotted terminals, and in the case of dotted terminals and the case of undotted terminals, switching states of respective switching devices of a half-bridge branch that is turned on are opposite.

In some embodiments, each of the switching devices comprises a fully-controlled power switching tube and an anti-parallel power diode.

### BRIEF DESCRIPTION OF THE DRAWINGS

The above and other objects, features, and potential advantages of the teachings of the present disclosure may be more easily understood according to the following description of example embodiments with reference to the accompanying drawings. The components in the accompanying drawings are only intended to show some of the principles of the present disclosure. In the accompanying drawings, same or similar technical features or components are represented by same or similar reference numerals.

In the accompanying drawings:

FIG. 1 is a circuit topology diagram of a motor driver in the prior art;

FIG. 2 is an example circuit topology diagram of an example motor driver incorporating teachings of the present disclosure;

FIG. 3 is an example circuit topology diagram of an example motor driver incorporating teachings of the present disclosure;

FIG. 4 is a circuit topology diagram of an example motor driver incorporating teachings of the present disclosure;

FIG. 5 is a circuit topology diagram of an example motor driver incorporating teachings of the present disclosure.

Reference numerals are as follows:

| | |
|---|---|
| 10, 20, 40: Motor driver | 202, 402: Rectifier circuit |
| 204, 404: Direct current link circuit | 206, 406: Inverter circuit |
| 208, 408: Filter circuit | 210, 410: Compensation circuit |
| R, S, and T: Input terminals | D1, D2, D3, D4, D5, D6, D7: |
| of three-phase power supply | Diode |
| 2042, 4042: Energy release branch | 2044, 4044: Capacitor branch |
| 2046: Half-bridge branch | 4046: First half-bridge branch |
| 4048: Second half-bridge branch | R1: Resistor |
| T1, T2, T3, T4, T5, T6, T7, | C1, C2: Capacitor |
| T8, T9, T10, T11, T12: | |
| Switching device | |
| V1, V2, V3: Midpoints of | V4: Midpoint of half-bridge |
| first DC/AC conversion branch | branch |
| to third DC/AC | |
| conversion branch | |
| V5: Midpoint of first half- | V6: Midpoint of second half- |
| bridge branch | bridge branch |
| Labc: Three-phase inductor | L12: Coupling inductor |
| L1: First inductor | L2: Second inductor |
| U, V, and W: Three phase | K1: Solid-state circuit |
| voltages | breaker |
| 1: First switch contact | 2: Second switch contact |
| CP: Center tap | O: Midpoint of capacitor branch |
| L11: First coupling inductor | L22: Second coupling inductor |

### DETAILED DESCRIPTION

Some embodiments of the teachings herein include a motor driver including a rectifier circuit, a direct current link circuit, an inverter circuit, a filter circuit, and a compensation circuit. The rectifier circuit includes three AC/DC conversion branches configured to convert an inputted alternating current voltage into a direct current voltage. The direct current link circuit is connected between a positive output terminal and a negative output terminal of the rectifier circuit, and the direct current link circuit includes: an energy release branch, a capacitor branch, and a half-bridge branch that are connected in parallel, where the capacitor branch includes two capacitors, and the half-bridge branch includes two switching devices.

The inverter circuit includes a first DC/AC conversion branch to a third DC/AC conversion branch arranged in parallel between a positive output terminal and a negative output terminal of the direct current link circuit, and each of the first DC/AC conversion branch to the third DC/AC conversion branch includes two switching devices. The filter circuit includes a three-phase inductor, head terminals of three inductors of the three-phase inductor are respectively connected to midpoints of the first DC/AC conversion branch to the third DC/AC conversion branch, and tail terminals of the three inductors output three phase voltages. The compensation circuit includes a coupling inductor with a center tap and a solid-state circuit breaker, and the coupling inductor is coupled to the three-phase inductor.

A moving point of the solid-state circuit breaker includes a first switch contact and a second switch contact. The first switch contact is connected to a head terminal of the coupling inductor, the second switch contact is connected to the center tap of the coupling inductor, the solid-state circuit breaker is connected to a midpoint of the half-bridge branch, and a tail terminal of the coupling inductor is connected to a midpoint of the capacitor branch. In this way, a compensation voltage can be generated through the coupling inductor to offset a DC/AC common-mode voltage.

In some embodiments, the coupling inductor includes a first inductor and a second inductor, and the center tap is connected between the first inductor and the second inductor. A number of turns of the first inductor is twice a number of turns of the second inductor, and the three inductors of the three-phase inductor have a same number of turns as the number of turns of the second inductor. In this way, the required number of turns of the coupling inductor can be obtained by connecting the solid-state circuit breaker to different switch contacts.

In some embodiments, switching states of the two switching devices of the half-bridge branch and which one of the first switch contact and the second switch contact to be connected are configured to be controlled according to a switching state of the switching device of each of the first DC/AC conversion branch to the third DC/AC conversion branch, so that a magnitude of a compensation voltage generated by the coupling inductor is equal to a magnitude of a common-mode voltage generated by the inverter circuit. In this way, a compensation voltage having the same magnitude and opposite polarities compared to the common-mode voltage may be generated to cancel the common-mode voltage.

In some embodiments, the head terminals of the coupling inductor and the three-phase inductor are dotted terminals or undotted terminals, and in the case of dotted terminals and the case of undotted terminals, switching states of the two switching devices of the half-bridge branch are opposite. In this way, different connection modes of the coupling inductors may be selected as required.

In some embodiments, each of the switching devices includes a fully-controlled power switching tube and an anti-parallel power diode.

In some embodiments, a motor driver includes a rectifier circuit, a direct current link circuit, an inverter circuit, a filter circuit, and a compensation circuit. The rectifier circuit includes three AC/DC conversion branch circuits configured to convert an inputted alternating current voltage into a direct current voltage. The direct current link circuit is connected between a positive output terminal and a negative output terminal of the rectifier circuit, and the direct current link circuit includes: an energy release branch, a capacitor branch, a first half-bridge branch, and a second half-bridge branch that are connected in parallel. The capacitor branch includes two capacitors, and each of the first half-bridge branch and the second half-bridge branch includes two switching devices.

The inverter circuit includes a first DC/AC conversion branch to a third DC/AC conversion branch arranged in parallel between a positive output terminal and a negative output terminal of the direct current link circuit, and each of the first DC/AC conversion branch to the third DC/AC conversion branch includes two switching devices. The filter circuit includes a three-phase inductor, head terminals of three inductors of the three-phase inductor are respectively connected to midpoints of the first DC/AC conversion branch to the third DC/AC conversion branch, and tail terminals of the three inductors output three phase voltages. The compensation circuit includes a first coupling inductor and a second coupling inductor.

A head terminal of the first coupling inductor is connected to a midpoint of the second half-bridge branch, a head terminal of the second coupling inductor is connected to a midpoint of the first half-bridge branch, and tail terminals of the second coupling inductor and the first coupling inductor are connected to a midpoint of the capacitor branch. In this way, a compensation voltage can be generated through the coupling inductor to offset a DC/AC common-mode voltage.

In some embodiments, a number of turns of the second coupling inductor is 3 times a number of turns of the first coupling inductor, and the three inductors of the three-phase inductor have a same number of turns as the number of turns of the first inductor.

In this way, by controlling closing states of the first half-bridge branch and the second half-bridge branch, one of the first coupling inductor and the second coupling inductor is controlled to be connected to a circuit, so as to obtain the required number of turns of the coupling inductor.

In some embodiments, switching states of the switching devices of each of the first half-bridge branch and the second half-bridge branch are configured to be controlled according to a switching state of each of the first DC/AC conversion branch to the third DC/AC conversion branch, so that a magnitude of a compensation voltage generated by the first coupling inductor or the second coupling inductor is equal to a magnitude of a common-mode voltage generated by the inverter circuit. In this way, by controlling closing states of the first half-bridge branch and the second half-bridge branch, a compensation voltage having the same magnitude and opposite polarities compared to the common-mode voltage may be generated to cancel the common-mode voltage.

In some embodiments, the head terminals of the first coupling inductor and the second coupling inductor are dotted terminals, and the head terminals of the first coupling inductor and the second coupling inductor and head terminals of the three-phase inductor are dotted terminals or undotted terminals. In the case of dotted terminals and the case of undotted terminals, switching states of respective switching devices of a half-bridge branch that is turned on are opposite. In this way, different connection modes of the coupling inductors may be selected as required.

The circuit topologies described herein can eliminate the common-mode voltage and reduce the possible damage to the motor bearing, thereby improving the system reliability. Since the common-mode voltage is eliminated, it is beneficial to EMI performance, thereby improving the system stability.

Discussion of the example implementations is merely intended to make a person skilled in the art better understand and implement the subject matter described in this specification, and is not intended to limit the protection scope of the claims, the applicability, or examples. Changes may be made to the functions and arrangements of the discussed elements without departing from the protection scope of the content of the present disclosure. Various processes or components may be omitted, replaced, or added in each example as needed. For example, the described method may be performed according to a sequence different from the sequence described herein, and steps may be added, omitted, or combined. In addition, features described with respect to some examples may also be combined in other examples.

As used herein, the term “including” and its variants represent open terms, meaning “including but not limited to”. The term “based on” means “at least partially based on”. The terms “one embodiment” and “an embodiment” mean “at least one embodiment”. The term “another embodiment” means “at least one other embodiment”. The terms “first”, “second”, and the like may represent different objects or the same object. Other definitions may be included explicitly or implicitly in the following. Unless the context clearly indicates otherwise, the definition of a term is consistent throughout the specification.

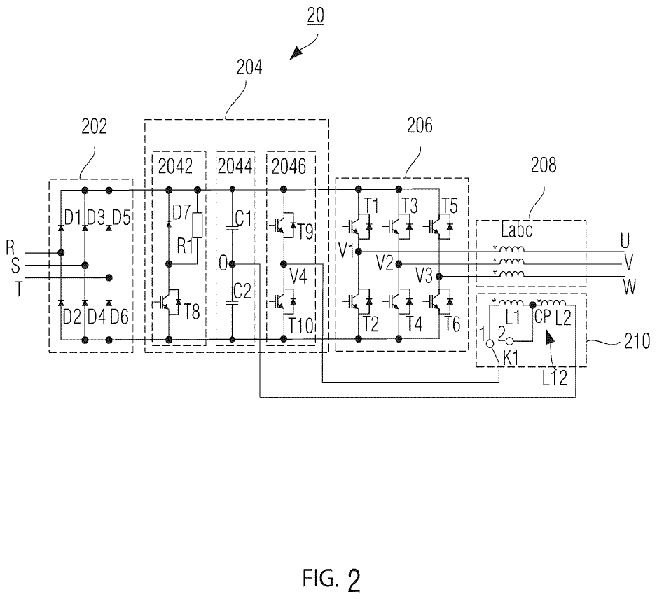

FIG. 2 is an example circuit topology diagram of a motor driver 20 incorporating teachings of the present disclosure. As shown in FIG. 2, the motor driver 20 includes a rectifier circuit 202, a direct current link circuit 204, an inverter circuit 206, a filter circuit 208, and a compensation circuit 210.

The rectifier circuit 202 is configured to convert an alternating current voltage inputted to the motor driver 20 into a direct current voltage. The rectifier circuit 202 includes three AC/DC conversion branch circuits, and each branch circuit includes two diodes connected in series in a same direction, such as diodes D1, D2, D3, D4, D5, and D6. Input terminals R, S, and T of a three-phase power supply of the motor driver are respectively connected to a node between two diodes of the corresponding branch circuit.

The direct current link circuit 204 is connected between the positive output terminal and the negative output terminal of the rectifier circuit 202 and is configured to filter the direct current voltage outputted by the rectifier circuit 202. In some embodiments, the direct current link circuit 204 includes an energy release branch 2042, a capacitor branch 2044, and a half-bridge branch 2046 connected in parallel.

The energy release branch 2042 may include, for example, a diode D7 and a resistor R1 connected in parallel. A cathode of the diode is connected to the positive output terminal of the rectifier circuit 202, the cathode of the diode is connected in series with a switching device T8, the switching device T8 is connected to the negative output terminal of the rectifier circuit 202.

The capacitor branch 2044 includes two capacitors C1 and C2 connected between the positive output terminal and the negative output terminal, and the half-bridge branch includes two switching devices T9 and T10 connected between the positive output terminal and the negative output terminal.

Each of the switching devices used in the present disclosure includes a fully-controlled power switching tube and an anti-parallel power diode. Specifically, each switching device may be composed of a single fully-controlled power transistor and a single diode, and an anode and a cathode of the diode are respectively connected to an emitter and a collector of the fully-controlled power transistor. In other examples of the present disclosure, the single fully-controlled power transistor may be composed of a plurality of fully-controlled power transistors in parallel, in series, or in series and parallel. Similarly, the single diode may also be composed of a plurality of diodes in parallel, in series, or in series and parallel. In the present disclosure, the fully-controlled power transistor is, for example, an insulated gate bipolar transistor (Insulated Gate Bipolar Transistor, IGBT).

In some embodiments, the switching device may also be composed of a single fully-controlled power field effect transistor and a single diode, and the anode and the cathode of the diode are respectively connected to a source and a drain of the fully-controlled power field effect transistor. Similarly, in other examples of the present disclosure, the single fully-controlled power field effect transistor may be composed of a plurality of fully-controlled power field effect transistors in parallel, in series, or in series and parallel. Similarly, the single diode may also be composed of a plurality of diodes in parallel, in series, or in series and parallel. In this example, the fully-controlled power field effect transistor is, for example, a fully-controlled enhanced field effect transistor and a fully-controlled depletion field effect transistor.

The specific types of switching devices are not limited, and for the sake of simplicity, the switching device is collectively referred to as a switching device for short in this specification.

The inverter circuit 206 is connected to the direct current link circuit 204, and includes a first DC/AC (DC/AC) conversion branch to a third DC/AC (DC/AC) conversion branch connected in parallel and arranged between the positive output terminal and the negative output terminal of the direct current link circuit 204, which are configured to convert a direct current voltage outputted by the direct current link circuit into an alternating current voltage.

In some embodiments, each of the first DC/AC conversion branch circuit to the third DC/AC conversion branch circuit includes two of switching devices T1, T2, T3, T4, T5, and T6, where the switching devices T1, T2, T3, T4, T5, and T6 are the same switching devices as the switching devices T8, T9, and T10. The filter circuit 208 is configured to filter a voltage outputted by the inverter circuit 206.

In some embodiments, the filter circuit 208 includes a three-phase inductor Labc, head terminals of three inductors of the three-phase inductor Labc are respectively connected to midpoints V1, V2, and V3 of the first DC/AC conversion branch to the third DC/AC conversion branch, and tail terminals of the three inductors output three phase voltages U, V, and W. The compensation circuit 210 includes a coupling inductor L12 with a center tap and a solid-state circuit breaker K1. The coupling inductor L12 is coupled to the three-phase inductor Labc.

The solid-state circuit breaker K1 may be switched between a first switch contact 1 and a second switch contact 2. The first switch contact 1 is connected to a head terminal of the coupling inductor L12, the second switch contact 2 is connected to the center tap CP of the coupling inductor L12, another end of the solid-state circuit breaker K1 is connected to a midpoint V4 of the half-bridge branch 2046, and a tail terminal of the coupling inductor L12 is connected to a midpoint O (that is, a point between the two capacitors) of the capacitor branch 2044.

In some embodiments, the coupling inductor L12 includes a first inductor L1 and a second inductor L2, and a center tap CP exists between the first inductor L1 and the second inductor L2. A number of turns of the first inductor L1 is twice a number of turns of the second inductor L2, and the three inductors of the three-phase inductor Labc have a same number of turns as the number of turns of the second inductor L2. Table 1 below shows the relationship between the three inductors (denoted as La, Lb, and Lc in the table below) of the three-phase inductor Labc and the number of turns of the first inductor L1 and the second inductor L2.

TABLE 1
Number of turns of inductor

| Inductor | Number of turns |
|---|---|
| La | N |
| Lb | N |
| Lc | N |
| L1 | 2N |
| L2 | N |

When the solid-state circuit breaker K1 is connected to the first switch contact 1, both the first inductor L1 and the second inductor L2 are connected to the circuit, and a number of turns of an equivalent inductor is equivalent to 3N. When the solid-state circuit breaker K1 is connected to the second switch contact 2, only the second inductor L2 is connected to the circuit, and the number of turns of the inductor is N.

Capacitors C1 and C2 share a direct current link voltage Vdc, and therefore each capacitor bears half a direct current bus voltage Vdc/2. A common-mode voltage may be expressed as Vcm=(V1+V2+V3)/3. According to the SVPWM (space voltage vector modulation) principle, the common-mode voltage may have four possible values (relative to the point O), as shown in Table 2. The common-mode voltage varies with different switch vectors. Table 2 below shows magnitudes of common-mode voltages corresponding to different switch vectors. Three digits of the DC/AC switch vector respectively represent closed and open states of the switching devices of the three DC/AC conversion branches. “1” represent that the switching devices (that is, T1, T3, and T5) above the DC/AC conversion branch are closed, and “0” represents that the switching devices (that is, T2, T4, and T6) below the DC/AC conversion branch are closed. Only one of the two switching devices of one branch is closed at the same time.

TABLE 2
Switch vector and common-mode voltage

| DC/AC switch vector | Common-mode voltage |
|---|---|
| 111 | Vdc/2 |
| 000 | −Vdc/2 |
| 110, 101, 011 | Vdc/6 |
| 001, 010, 100 | −Vdc/6 |

The switching states of the two switching devices of the half-bridge branch and a connection mode of the solid-state circuit breaker K1 may be controlled based on the switching states of each of the first DC/AC conversion branch to the third DC/AC conversion branch (that is, which switching device is closed and which switching device is open), so that the coupling inductor L1 or L2 generates a compensation voltage with an appropriate magnitude on the three-phase inductor Labc. The compensation voltage may offset the common-mode voltage, and even completely eliminate the common-mode voltage theoretically.

TABLE 3
Switch vector and compensation voltage

| DC/AC switch | | | | Compensation |
|---|---|---|---|---|
| vector | T9 | T10 | K1 | voltage |
| 111 | 0 | 1 | 2 | −Vdc/2 |
| 000 | 1 | 0 | 2 | Vdc/2 |
| 110, 101, 011 | 0 | 1 | 1 | −Vdc/6 |
| 001, 010, 100 | 1 | 0 | 1 | Vdc/6 |

Table 3 represents the states of T9, T10, and K1 and the magnitudes of the generated compensation voltages in the case of different DC/AC switch vectors. The data in Table 3 is to be described in detail below.
1) When the switch vector is 111, the generated common-mode voltage is Vdc/2. In this case, T9 is controlled to be open, T10 is controlled to be closed, and K1 is connected to the second switch contact 2. A voltage of −Vdc/2 is to be applied to the inductor L2, and a coupling voltage of −Vdc/2 may be generated on three windings of Labc, thereby canceling the common-mode voltage.
2) When the switch vector is 000, the generated common-mode voltage is −Vdc/2. In this case, T9 is controlled to be closed, T10 is controlled to be open, and K1 is connected to the second switch contact 2. A voltage of Vdc/2 is to be applied to the inductor L2, and a coupling voltage of Vdc/2 is generated on three windings of Labc, thereby canceling the common-mode voltage.
3) When the switch vector is 110, 101, or 011, the generated common-mode voltage is Vdc/6. In this case, T9 is controlled to be open, T10 is controlled to be closed, K1 is connected to the first switch contact 1, and a total number of turns of L1+L2 is 3N. A voltage of −Vdc/2 is to be applied to the inductor L1+L2, and a coupling voltage of −Vdc/6 is generated on three windings of Labc, thereby canceling the common-mode voltage.
4) When the switch vector is 001, 010, or 100, the common-mode voltage is −Vdc/6. In this case, T9 is controlled to be closed, T10 is controlled to be open, K1 is connected to the first switch contact 1, and a total number of turns of L1+L2 is 3N. A voltage of Vdc/6 is to be applied to the inductor L1+L2, and a coupling voltage of Vdc/6 is generated on three windings of Labc, thereby canceling the common-mode voltage.

In this way, the switching states of the two switching devices T9 and T10 of the half-bridge branch 2046 and which one of the first contact 1 and the second contact 2 to be connected are controlled based on the switching states of the switching devices of each of the first DC/AC conversion branch to the third DC/AC conversion branch, so that a compensation voltage with the same magnitude as the common-mode voltage generated by the inverter circuit can be generated, thereby canceling the common-mode voltage.

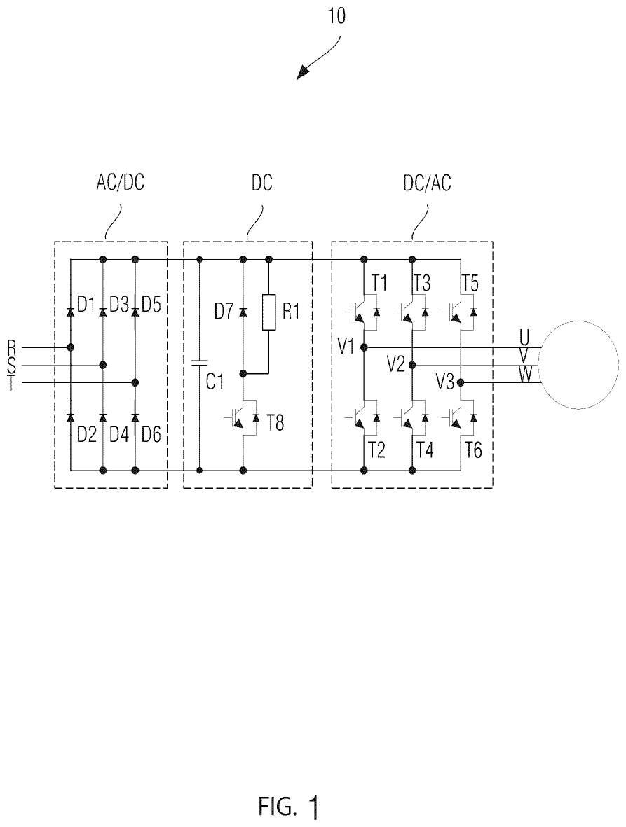

The circuit topology of the motor driver shown in FIG. 2 is only an example embodiment. In some embodiments, the rectifier circuit, the inverter circuit, the filter circuit, and the energy release circuit and the capacitor circuit in the direct current link circuit may adopt the circuit topology in the prior art, and the specific circuit topology may be the same as or different from that shown in FIG. 1, which is not limited in the present disclosure.

In order to verify the performance of the motor driver using the circuit topology shown in FIG. 2, the inventor conducted a simulation experiment. According to the experimental results, the generated common-mode voltage has a voltage of four levels without using the common-mode voltage compensation circuit according to the present disclosure, where a peak voltage is equal to a direct current bus voltage. In the case of using the compensation circuit, the common-mode voltage can be greatly reduced.

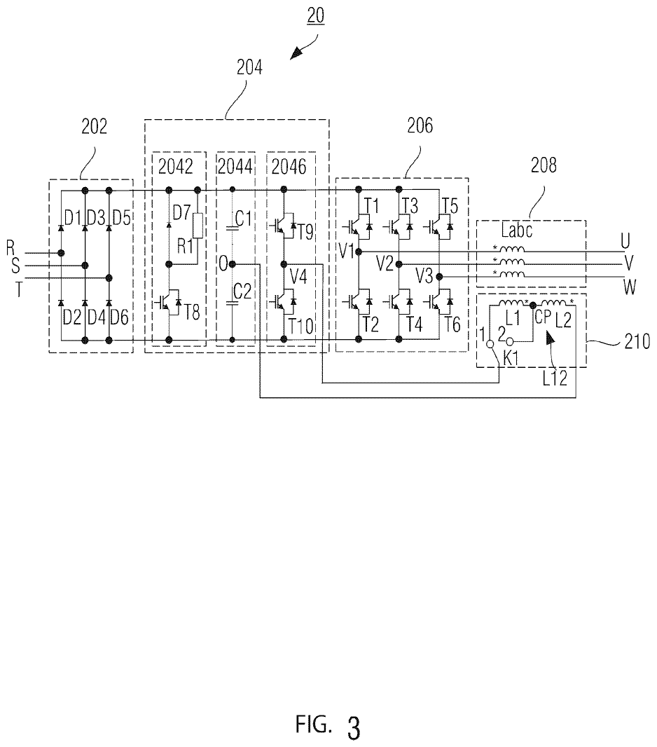

FIG. 3 is a circuit topology diagram of an example motor driver incorporating teachings of the present disclosure. In the circuit topology of the motor driver shown in FIG. 3, a connection direction of the coupling inductor in the compensation circuit is opposite to that of the coupling inductor L12 in the circuit topology shown in FIG. 2. In FIG. 1, head terminals of the coupling inductor L12 and the three-phase inductor Labc are dotted terminals, while in FIG. 2, head terminals of the coupling inductor L12 and the three-phase inductor Labc are undotted terminals.

In the motor driver shown in FIG. 3, the switching states of the two switching devices T9 and T10 of the half-bridge branch and which contact point connected to K1 may be controlled according to the following Table 4. It can be seen that in this case, the switching states of T9 and T10 are opposite to the switching states in a case that the head terminals of the coupling inductor L12 and the three-phase inductor Labc in FIG. 1 are dotted terminals, and the connection mode of K1 is the same as that in FIG. 1.

TABLE 4

| DC/AC Switch | | | | Compensation |
|---|---|---|---|---|
| Vector | T9 | T10 | K1 | voltage |
| 111 | 1 | 0 | 2 | −Vdc/2 |
| 000 | 0 | 1 | 2 | Vdc/2 |
| 110, 101, 011 | 1 | 0 | 1 | −Vdc/6 |
| 001, 010, 100 | 0 | 1 | 1 | Vdc/6 |

Except that the connection direction of the coupled capacitors is opposite, the circuit topology of the motor driver shown in FIG. 3 is the same as that of the motor driver shown in FIG. 2, and the same circuit assembly is given the same reference numerals. The details are not described herein again.

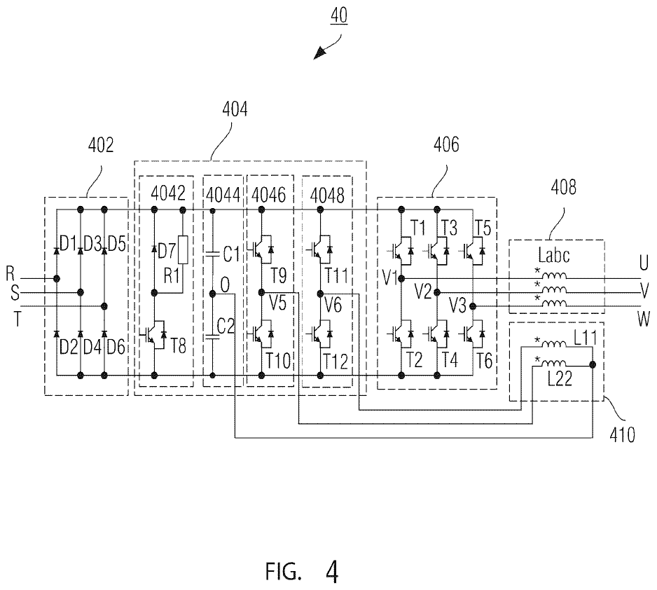

FIG. 4 is a circuit topology diagram of an example motor driver 40 incorporating teachings of the present disclosure. As shown in FIG. 4, the motor driver 40 includes a rectifier circuit 402, a direct current link circuit 404, an inverter circuit 406, a filter circuit 408, and a compensation circuit 410. The rectifier circuit 402 is configured to convert an inputted alternating current voltage into a direct current voltage.

The rectifier circuit 402 includes three AC/DC conversion branch circuits, and each branch circuit includes two diodes connected in series in a same direction, such as diodes D1, D2, D3, D4, D5, and D6. Input terminals R, S, and T of a three-phase power supply of the motor driver are respectively connected to a node between two diodes of the corresponding branch circuit.

The direct current link circuit 404 is connected between a positive output terminal and a negative output terminal of the rectifier circuit 402. The direct current link circuit 404 includes an energy release branch 4042, a capacitor branch 4044, a first half-bridge branch 4046, and a second half-bridge branch 4048 that are connected in parallel.

The energy release branch 4042 may adopt a common circuit topology, and the details are not described herein again.

The capacitor branch 4044 includes two capacitors C1 and C2 connected between the positive output terminal and the negative output terminal.

The first half-bridge branch 4046 includes two switching devices T9 and T10, and the second half-bridge branch 4048 includes two switching devices T11 and T12.

The inverter circuit 406 includes a first DC/AC conversion branch to a third DC/AC conversion branch arranged in parallel between a positive output terminal and a negative output terminal of the direct current link circuit 404, and each of the first DC/AC conversion branch to the third DC/AC conversion branch includes two of switching devices T1, T2, T3, T4, T5, and T6.

The filter circuit 408 includes a three-phase inductor Labc, head terminals of three inductors of the three-phase inductor Labc are respectively connected to midpoints V1, V2, and V3 of the first DC/AC conversion branch to the third DC/AC conversion branch, and tail terminals of the three inductors output three phase voltages U, V, and W.

The compensation circuit 410 includes a first coupling inductor L11 and a second coupling inductor L22.

A head terminal of the first coupling inductor L11 is connected to a midpoint V6 of the second half-bridge branch 4048, a head terminal of the second coupling inductor L22 is connected to a midpoint V5 of the first half-bridge branch 4046, and tail terminals of the first coupling inductor L11 and the second coupling inductor L22 are connected to a midpoint O of the capacitor branch 4044.

A number of turns of the second coupling inductor L22 is three times a number of turns of the first coupling inductor L11, and the three inductors of the three-phase inductor Labc have a same number of turns as the number of turns of the first coupling inductor L11.

TABLE 5
Number of turns of inductor

| Inductor | Number of turns |
|---|---|
| La | N |
| Lb | N |
| Lc | N |
| L1 | N |
| L2 | 3N |

Capacitors C1 and C2 share a direct current link voltage Vdc, and therefore each capacitor bears half a direct current bus voltage Vdc/2. A common-mode voltage may be expressed as Vcm=(V1+V2+V3)/3. According to the SVPWM principle, the common-mode voltage may have four possible values (relative to the point O), as shown in Table 6. The common-mode voltage varies with different switch vectors. Table 6 below shows magnitudes of common-mode voltages corresponding to different switch vectors. Three digits of the DC/AC switch vector respectively represent closed and open states of the switching devices of the three DC/AC conversion branches. “1” represent that the switching devices (that is, T1, T3, and T5) above the DC/AC conversion branch are closed, and “0” represents that the switching devices (that is, T2, T4, and T6) below the DC/AC branch are closed. Only one of the two switching devices of one branch is closed at the same time.

TABLE 6
Switch vector and common-mode voltage

| DC/AC switch vector | Common-mode voltage |
|---|---|
| 111 | Vdc/2 |
| 000 | −Vdc/2 |
| 110, 101, 011 | Vdc/6 |
| 001, 010, 100 | −Vdc/6 |

The switching states of the switching devices of the first half-bridge branch and the second half-bridge branch may be controlled based on the switch vectors (switching states of each of the first DC/AC conversion branch to the third DC/AC conversion branch), so that the first coupling inductor L11 or the second coupling inductor L22 generates a compensation voltage with an appropriate magnitude on the three-phase inductor Labc. The compensation voltage may offset the common-mode voltage, and even completely eliminate the common-mode voltage theoretically.

TABLE 7
Switch vector and compensation voltage

| DC/AC switch | | | | | Compensation |
|---|---|---|---|---|---|
| vector | T9 | T10 | T11 | T12 | voltage |
| 111 | 0 | 0 | 0 | 1 | −Vdc/2 |
| 000 | 0 | 0 | 1 | 0 | Vdc/2 |
| 110, 101, 011 | 0 | 1 | 0 | 0 | −Vdc/6 |
| 001, 010, 100 | 1 | 0 | 0 | 0 | Vdc/6 |

The data in Table 7 represents the states of T9, T10, and K1 and the magnitudes of the generated compensation voltages in the case of different DC/AC switch vectors. The data in Table 7 is to be described in detail below.
1) When the switch vector is 111, the generated common-mode voltage is Vdc/2. In this case, T9, T10, and T11 are controlled to be open, and T12 is controlled to be closed. A voltage of −Vdc/2 is to be applied to the inductor L1, and a coupling voltage of −Vdc/2 is generated on three windings of Labc, thereby canceling the common-mode voltage.
2) When the switch vector is 000, the generated common-mode voltage is −Vdc/2. In this case, T9, T10, and T12 are controlled to be open, and T11 is controlled to be closed. A voltage of Vdc/2 is to be applied to the inductor L1, and a coupling voltage of Vdc/2 is generated on three windings of Labc, thereby canceling the common-mode voltage.
3) When the switch vector is 110, 101, or 011, the generated common-mode voltage is Vdc/6. In this case, T9, T11, and T12 are controlled to be open, and T10 is controlled to be closed. A voltage of −Vdc/2 is to be applied to the inductor L2, and a coupling voltage of −Vdc/6 is generated on three windings of Labc, thereby canceling the common-mode voltage.
4) When the switch vector is 001, 010, or 100, the common-mode voltage is −Vdc/6. In this case, T10, T11, and T12 are controlled to be open, and T9 is controlled to be closed. A voltage of Vdc/6 is to be applied to the inductor L2, and a coupling voltage of Vdc/6 is generated on three windings of Labc, thereby canceling the common-mode voltage.

The circuit topology of the motor driver shown in FIG. 4 is only an example embodiment. In some embodiments, the rectifier circuit, the inverter circuit, the filter circuit, and the energy release circuit and the capacitor circuit in the direct current link circuit may adopt the circuit topology in the prior art, and the specific circuit topology may be the same as or different from that shown in FIG. 4, which is not limited in the present disclosure.

To verify the performance of the motor driver using the circuit topology shown in FIG. 4, the inventor conducted a simulation experiment. According to the experimental results, the generated common-mode voltage has a voltage of four levels without using the common-mode voltage compensation circuit according to the present invention, where a peak voltage is equal to a direct current bus voltage. In the case of using the compensation circuit, the common-mode voltage can be greatly reduced.

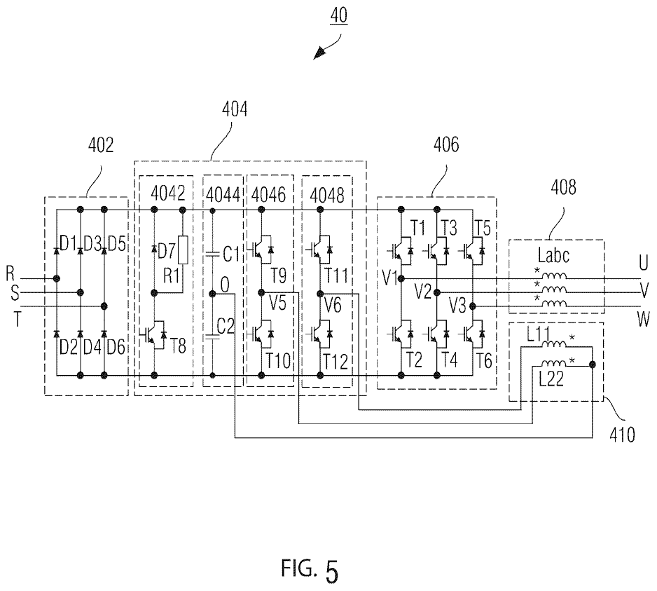

FIG. 5 is a circuit topology diagram of an example motor driver incorporating teachings of the present disclosure. In the circuit topology of the motor driver shown in FIG. 5, a connection direction of the first coupling inductor L11 and the second coupling inductor L22 in the compensation circuit 408 is opposite to the connection direction of the first coupling inductor L11 and the second coupling inductor L22 in the circuit topology shown in FIG. 4. In FIG. 4, head terminals of the first coupling inductor L11 and the second coupling inductor L22 and the three-phase inductor Labc are dotted terminals, while in FIG. 5, head terminals of the first coupling inductor L11 and the second coupling inductor L22 and the three-phase inductor Labc are undotted terminals.

In the motor driver shown in FIG. 5, the switching states of the switching devices T9, T10, T11, and T12 of the first half-bridge branch 4046 and the second half-bridge branch 4048 may be controlled based on the following Table 8. It can be seen that in this case, compared with the case in which the head terminals of the first coupling inductor L11, the second coupling inductor L22, and the three-phase inductor Labc in FIG. 4 are dotted terminals, in a case that the switch vectors are the same, turn-on half-bridge branches are the same, but the switching devices that are turned on in the turn-on half-bridge branch are opposite.

TABLE 8
Switch vector and compensation voltage

| DC/AC switch | | | | | Compensation |
|---|---|---|---|---|---|
| vector | T9 | T10 | T11 | T12 | voltage |
| 111 | 0 | 0 | 1 | 0 | −Vdc/2 |
| 000 | 0 | 0 | 0 | 1 | Vdc/2 |
| 110, 101, 011 | 1 | 0 | 0 | 0 | −Vdc/6 |
| 001, 010, 100 | 0 | 1 | 0 | 0 | Vdc/6 |

Except that the connection direction of the coupled capacitors is opposite, the circuit topology of the motor driver shown in FIG. 5 is the same as that of the motor driver shown in FIG. 2, and the same circuit assembly is given the same reference numerals. The details are not described herein again.

The compensation voltage is generated by using the coupling inductor, and the common-mode voltage can be offset. The technical solution according to the present disclosure may have at least one of the following advantages.

In some embodiments, by adding a half-bridge branch and a coupling tap inductor to the circuit topology of the motor driver, a compensation voltage of an appropriate magnitude may be generated to offset the DC/AC common-mode voltage. In addition, the motor bearing current can be eliminated, and the possible damage to the motor bearing can be reduced, thereby improving the system reliability.

In some embodiments, by adding an H-bridge branch (two half-bridge branches) and two coupling inductors to the circuit topology of the motor driver, a compensation voltage of an appropriate magnitude may be generated to offset the DC/AC common-mode voltage.

In addition, the motor bearing current can be eliminated, and the possible damage to the motor bearing can be reduced, thereby improving the system reliability.

In addition, the motor driver can eliminate the common-mode voltage, which facilitates EMI performance and improves the system stability. Example embodiments are described in the specific implementation described above with reference to the accompanying drawings, but do not represent all embodiments that can be implemented or fall within the protection scope of the claims. The term “example” used throughout this specification means “serving as an example, instance, or illustration” and does not mean “preferred” or “advantageous” over other embodiments. The specific implementation includes specific details for the purpose of providing an understanding of the described technology. However, these techniques may be implemented without these specific details. In some instances, in order to avoid obscuring the concepts of the described embodiments, well-known structures and devices are shown in a form of block diagram.

The above description of the present disclosure is provided to enable any person of ordinary skill in the art to implement or use the present disclosure. Various modifications to the present disclosure are obvious to those skilled in the art, and the general principles defined herein may also be applied to other variations without departing from the protection scope of the present disclosure. Therefore, the present disclosure is not limited to the examples and designs described herein, but is to accord with the widest scope consistent with the principles and novel features disclosed herein.

The above are only example embodiments of the present disclosure and are not intended to limit the scope thereof. Any modification, equivalent replacement, or improvement made within the spirit and principle of the present disclosure shall be included in the protection scope thereof.

What is claimed is:

1. A motor driver comprising:
a rectifier circuit including three AC/DC conversion branches to convert an inputted alternating current voltage into a direct current voltage;
a direct current link circuit connected between a positive output terminal and a negative output terminal of the rectifier circuit, wherein the direct current link circuit comprises an energy release branch, a capacitor branch and a half-bridge branch connected in parallel, the capacitor branch comprises two capacitors, and the half-bridge branch comprises two switching devices;
an inverter circuit including a first DC/AC conversion branch to a third DC/AC conversion branch arranged in parallel between a positive output terminal and a negative output terminal of the direct current link circuit, and each of the first DC/AC conversion branch to the third DC/AC conversion branch comprises two of switching devices;
a filter circuit including a three-phase inductor, head terminals of three inductors of the three-phase inductor respectively connected to midpoints of the first DC/AC conversion branch to the third DC/AC conversion branch, and tail terminals of the three inductors output three phase voltages; and
a compensation circuit including a coupling inductor with a center tap and a solid-state circuit breaker, wherein the coupling inductor is coupled to the three-phase inductor;
wherein a moving point of the solid-state circuit breaker comprises a first switch contact and a second switch contact, the first switch contact is connected to a head terminal of the coupling inductor, the second switch contact is connected to the center tap of the coupling inductor, the solid-state circuit breaker is connected to a midpoint of the half-bridge branch, and a tail terminal of the coupling inductor is connected to a midpoint of the capacitor branch.

2. The motor driver according to claim 1, wherein:
the coupling inductor comprises a first inductor and a second inductor;
the center tap is connected between the first inductor and the second inductor;
a number of turns of the first inductor is twice a number of turns of the second inductor; and
the three inductors of the three-phase inductor have a matching number of turns as the number of turns of the second inductor.

3. The motor driver according to claim 1, wherein switching states of the two switching devices of the half-bridge branch and which one of the first switch contact and the second switch contact to be connected are both controlled according to a switching state of the switching device of each of the first DC/AC conversion branch to the third DC/AC conversion branch, so that a magnitude of a compensation voltage generated by the coupling inductor is equal to a magnitude of a common-mode voltage generated by the inverter circuit.

4. The motor driver according to claim 1, wherein the switching states of the two switching devices of the half-bridge branch are opposite.

5. The motor driver according to claim 1, wherein each of the switching devices comprises a fully-controlled power switching tube and an anti-parallel power diode.

6. A motor driver comprising:
a rectifier circuit including three AC/DC conversion branch circuits configured to convert an inputted alternating current voltage into a direct current voltage;
a direct current link circuit connected between a positive output terminal and a negative output terminal of the rectifier circuit, wherein the direct current link circuit comprises an energy release branch, a capacitor branch, a first half-bridge branch, and a second half-bridge branch connected in parallel, wherein the capacitor branch comprises two capacitors and each of the first half-bridge branch and the second half-bridge branch comprises two switching devices;
an inverter circuit including a first DC/AC conversion branch to a third DC/AC conversion branch arranged in parallel between a positive output terminal and a negative output terminal of the direct current link circuit, wherein each of the first DC/AC conversion branch to the third DC/AC conversion branch comprises two switching devices;
a filter circuit including a three-phase inductor, wherein head terminals of three inductors of the three-phase inductor are respectively connected to midpoints of the first DC/AC conversion branch to the third DC/AC conversion branch, and tail terminals of the three inductors output three phase voltages; and
a compensation circuit including first coupling inductor and a second coupling inductor;
wherein a head terminal of the first coupling inductor is connected to a midpoint of the second half-bridge branch, a head terminal of the second coupling inductor is connected to a midpoint of the first half-bridge branch, and tail terminals of the second coupling inductor and the first coupling inductor are connected to a midpoint of the capacitor branch.

7. The motor driver according to claim 6, wherein:
a number of turns of the second coupling inductor is 3 times a number of turns of the first coupling inductor; and
the three inductors of the three-phase inductor have a same number of turns as the number of turns of the first coupling inductor.

8. The motor driver according to claim 6, wherein switching states of the switching devices of each of the first half-bridge branch and the second half-bridge branch controlled according to a switching state of each of the first DC/AC conversion branch to the third DC/AC conversion branch, so that a magnitude of a compensation voltage generated by the first coupling inductor or the second coupling inductor is equal to a magnitude of a common-mode voltage generated by the inverter circuit.

9. The motor driver according to claim 6, wherein:
the head terminals of the first coupling inductor and the second coupling inductor are dotted terminals; and
the case of dotted terminals and the case of undotted terminals, switching states of respective switching devices of a half-bridge branch that is turned on are opposite.

10. The motor driver according to claim 6, wherein each of the switching devices comprises a fully-controlled power switching tube and an anti-parallel power diode.
